(19) United States
(12) Patent Application Publication
(10) Pub. No.: US 2007/0170917 A1
(43) Pub. Date: Jul. 26, 2007

(54) Magnetic resonance imaging with real-time magnetic filed mapping

(75) Inventors: Michael R. Thompson, Cleveland Heights, OH (US); David L. Foxall, Mentor, OH (US)

Correspondence Address: PHILIPS INTELLECTUAL PROPERTY & STANDARDS, 595 MINER ROAD, CLEVELAND, OH, 44143, US

(73) Assignee: Koninklijke Philips Electronics N.V., Eindhoven (NL)

(21) Appl. No.: 10/597,062

(22) PCT Filed: Jan. 5, 2005
(86) PCT No.: PCT/IB05/50052

§ 371 Date: Jul. 10, 2006

(51) Int. Cl. G01V 3/00

(52) U.S. Cl. 324/307; 324/318

(57) ABSTRACT

A magnetic resonance imaging scanner (10) performs magnetic resonance imaging. The scanner (10) includes a main magnet (20) generating a main magnetic field, magnetic field gradient coils (30), and at least one radio frequency antenna (32, 34). At least one magnetic field sensor (32, 34, 64, 66, 68, 70, 72) measures spatial data corresponding to the main magnetic field. A processor (60) processes the measured spatial data corresponding to the main magnetic field to determine at least one main magnetic field nonuniformity parameter. The at least one magnetic field sensor (32, 34, 64, 66, 68, 70, 72) and the processor (60) operate concurrently with the magnetic resonance imaging.

The following relates to the magnetic resonance arts. It finds particular application in magnetic resonance imaging scanners employing substantial amounts of steel to shim or shape the main Bₒ magnetic field, and will be described with particular reference thereto. However, it also finds application in other magnetic resonance imaging scanners and in magnetic resonance spectroscopy and imaging techniques that benefit from maintaining a substantially uniform main Bₒ magnetic field or that benefit from information about non-uniformities of the main Bₒ magnetic field.

Magnetic resonance imaging scanners are increasing utilizing steel or other ferromagnetic material within the main Bₒ magnetic field. Shims of steel or other ferromagnetic material are commonly used to correct magnets for manufacturing flaws. Rings, bars, or other configurations of steel or other ferromagnetic material are also sometimes incorporated into magnet designs. For example, in short bore magnetic resonance imaging scanners steel rings or other steel structures can be used to stretch the uniform magnetic field to compensate for the shorter bore, and to compensate for main Bₒ magnetic field non-uniformities introduced by the shortening of the bore.

While addition of steel or other ferromagnetic material in the main Bₒ magnetic field can be beneficial to initial field homogeneity, a problem can arise in that cycling of magnetic field gradients during extended imaging sessions can induce eddy currents that heat the steel. Such heating affects the magnetic characteristics of the steel and can shift the main Bₒ magnetic field and/or introduce spatial non-uniformities in the main field over the course of an imaging session.

There are other situations in which the main Bₒ magnetic field can drift or otherwise change over the course of an imaging session. If, for example, the main Bₒ magnetic field is not fully stabilized, such as if the overall field intensity or the field-of-view is adjusted, long time-constant transients can manifest as main field drift or distortion. Imperfections in the main magnet power controller electronics can also introduce drift.

To account for non-uniformities of the main Bₒ magnetic field, the main field can be mapped using various techniques, such as the FASTERMAP technique described in Shen et al., Magn. Reson. Med. vol. 38, pages 834-839 (1997). These mapping techniques typically involve several seconds of data acquisition and are performed prior to performing an imaging session. They do not account for changes in the main Bₒ field due to heating of steel, drift in the main magnet current, or the like, which occur over the course of the imaging session or during an individual scan.

The present invention contemplates an improved apparatus and method that overcomes the aforementioned limitations and others.

According to one aspect, a magnetic resonance method is provided. Magnetic resonance imaging is performed in a main magnetic field. Spatial data corresponding to the main magnetic field is measured. At least one main magnetic field nonuniformity parameter is determined from the spatial data corresponding to the main magnetic field. The measuring and determining are performed concurrently with the performing of magnetic resonance imaging.

According to another aspect, a magnetic resonance imaging apparatus is disclosed. A means is provided for performing magnetic resonance imaging in a main magnetic field. A means is provided for measuring spatial data corresponding to the main magnetic field. A means is provided for determining at least one main magnetic field nonuniformity parameter from the spatial data corresponding to the main magnetic field.

According to yet another aspect, a magnetic resonance imaging apparatus is disclosed. A magnetic resonance imaging scanner performs magnetic resonance imaging.

The scanner includes a main magnet generating a main magnetic field, magnetic field gradient coils, and at least one radio frequency antenna. At least one magnetic field sensor measures spatial data corresponding to the main magnetic field. A processor is programmed to determine a main magnetic field nonuniformity parameter.

One advantage resides in providing main Bₒ magnetic field mapping over the course of an imaging session.

Another advantage resides in compensating for changes in the main Bₒ magnetic field occurring over the course of an imaging acquisition or session.

Yet another advantage resides in providing more accurate imaging by maintaining a substantially uniform main Bₒ magnetic field over the course of an imaging session.

Still yet another advantage resides in providing information on main Bₒ magnetic field non-uniformities concurrently with magnetic resonance imaging. The provided information can be used to adjust the main Bₒ magnetic field to compensate for the field non-uniformities. Additionally or alternatively, the provided information can be used post-data acquisition to correct the acquired magnetic resonance imaging data for artifacts caused by the field non-uniformities.

Numerous additional advantages and benefits will become apparent to those of ordinary skill in the art upon reading the following detailed description of the preferred embodiments.

The invention may take form in various components and arrangements of components, and in various process operations and arrangements of process operations.

The drawings are only for the purpose of illustrating preferred embodiments and are not to be construed as limiting the invention.

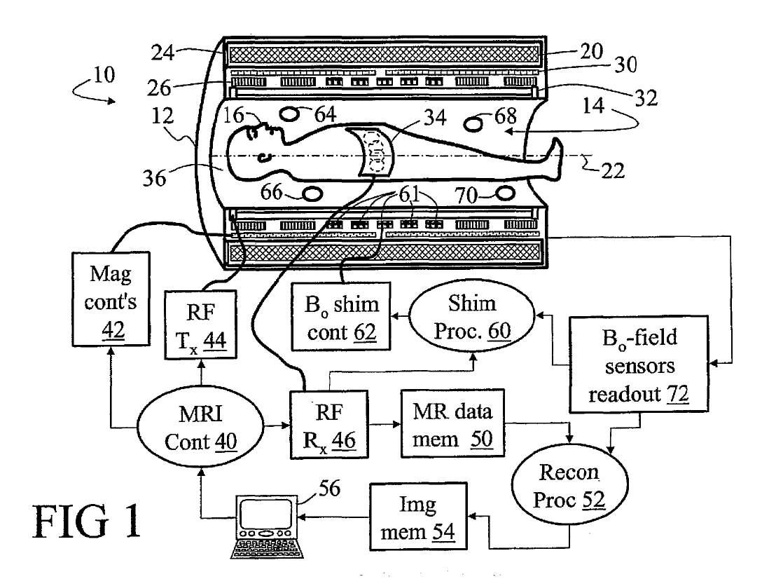

FIG. 1 diagrammatically shows a magnetic resonance imaging system implementing rapid main Bₒ magnetic field mapping operating concurrently with magnetic resonance imaging.

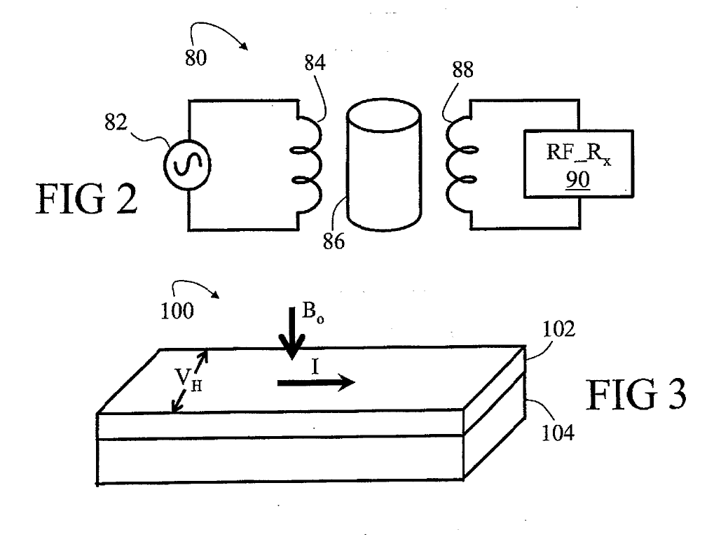

FIG. 2 diagrammatically shows a magnetic resonance-based magnetic field sensor for measuring the main Bₒ magnetic field.

FIG. 3 diagrammatically shows a Hall effect magnetic field sensor for measuring the main Bₒ magnetic field.

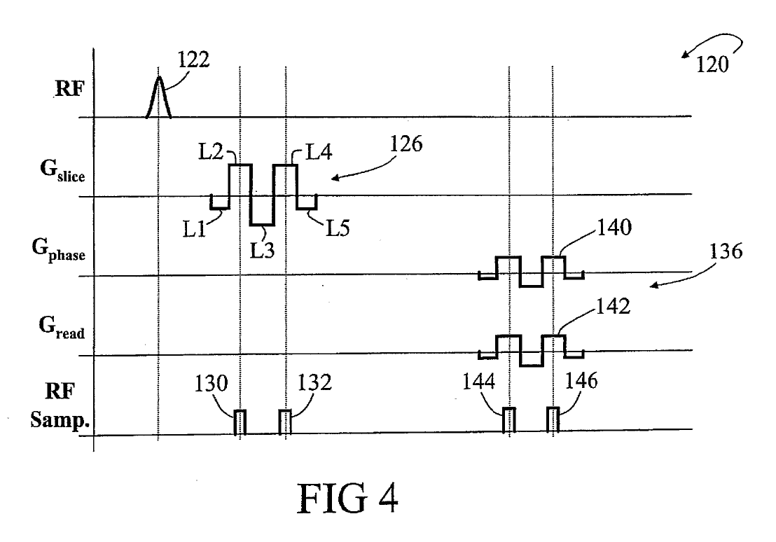

FIG. 4 shows a magnetic resonance pulse sequence implementing one embodiment of rapid main Bₒ magnetic field mapping.

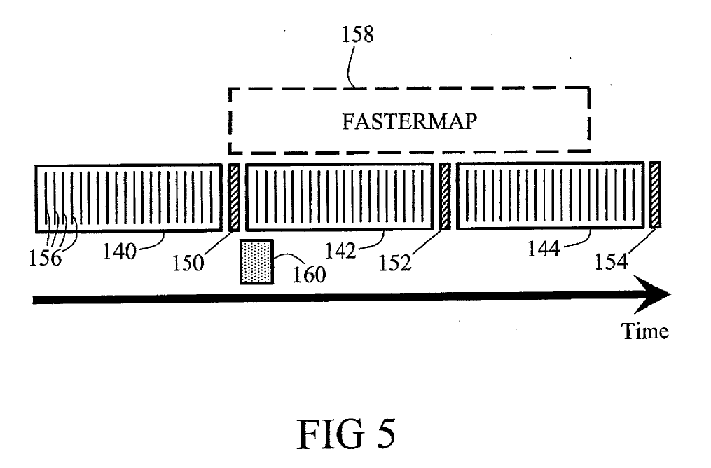

FIG. 5 plots a timing sequence of imaging frames or dynamics with interspersed main Bₒ magnetic field mapping sequence measurement and calculation timeframes. A timeframe for a typical FASTERMAP magnetic field mapping sequence is also illustrated for comparison.

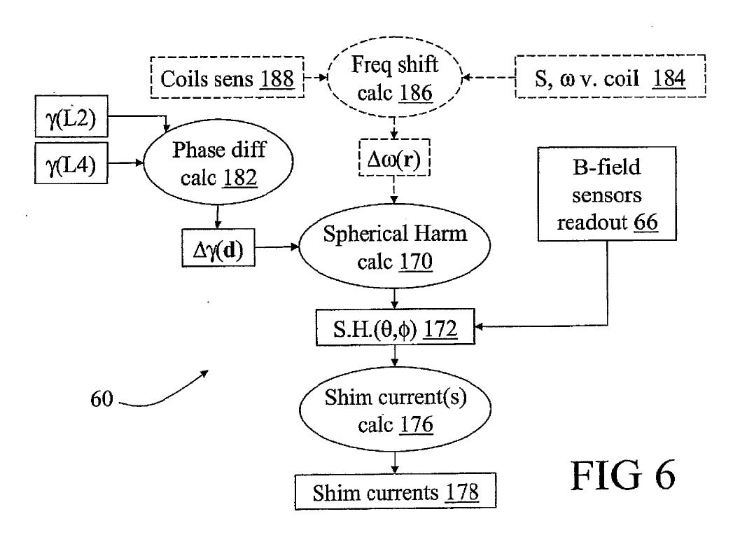

FIG. 6 diagrammatically shows details of the shimming processor of FIG. 1.

With reference to FIG. 1, a magnetic resonance imaging scanner 10 includes a housing 12 defining a generally cylindrical scanner bore 14 inside of which an associated imaging subject 16 is disposed. Main magnetic field coils 20 are disposed inside the housing 12, and produce a main Bₒ magnetic field directed generally along and parallel to a central axis 22 of the scanner bore 14. The main magnetic field coils 20 are typically superconducting coils disposed inside cryoshrouding 24, although other main magnet geometries and magnetic sources may also be used.

In one embodiment, an array or structure 26 of steel or another ferromagnetic material is arranged inside the housing 12. The array or structure 26 interacts with the magnetic field produced by the main magnetic field coils 20 to provide a uniform main Bₒ magnetic field over a selected field of view. While the array or structure 26 is shown inside the housing 12, it may also be arranged inside of the scanner bore 14, for example by mounting the steel or other ferromagnetic material on a dielectric former that slides into the bore 14. The steel or other ferromagnetic material of the array or structure 26 is preferably laminated, constructed of stacked steel plates, formed as a composite with a non-magnetic material, or otherwise configured to reduce eddy currents.

Nonetheless, some eddy currents may form in the array or structure 26. These eddy currents can heat the steel or other ferromagnetic material and cause changes in the magnetic properties of the array or structure 26 over the course of an imaging session. The housing 12 also houses or supports magnetic field gradient coils 30 for selectively producing magnetic field gradients parallel to the central axis 22 of the bore 14, along in-plane directions transverse to the central axis 22, or along other selected directions. The housing 12 further houses or supports a radio frequency body coil 32 for selectively exciting and/or detecting magnetic resonances. A coil array 34 disposed inside the bore 14 includes a plurality of coils, specifically four coils in the illustrated example coil array 34, although other numbers of coils can be used. The coil array 34 can be used as a phased array of receivers for parallel imaging, as a sensitivity encoding (SENSE) coil for SENSE imaging, or the like. In one embodiment, the coil array 34 is an array of surface coils disposed close to the imaging subject 16. The housing 12 typically includes a cosmetic inner liner 36 defining the scanner bore 14.

The coil array 34 can be used for receiving magnetic resonances that are excited by the whole body coil 32, or the magnetic resonances can be both excited and received by the coil array 34. Moreover, it is also contemplated to excite magnetic resonance with the coil array 34 and detect the magnetic resonance with the whole body coil 32. It will be appreciated that if one of the coils 32, 34 is used for both transmitting and receiving, then the other one of the coils 32, 34 is optionally omitted.

The main magnetic field coils 20 produce a main magnetic field Bₒ. A magnetic resonance imaging controller 40 operates magnet controllers 42 to selectively energize the magnetic field gradient coils 30, and operates a radio frequency transmitter 44 coupled to the radio frequency coil 32 as shown, or coupled to the coils array 34, to selectively energize the radio frequency coil or coil array 32, 34. By selectively operating the magnetic field gradient coils 30 and the radio frequency coil 32 or coil array 34 magnetic resonance is generated and spatially encoded in at least a portion of a region of interest of the imaging subject 16. By applying selected magnetic field gradients via the gradient coils 30, a selected k-space trajectory is traversed, such as a Cartesian trajectory, a plurality of radial trajectories, or a spiral trajectory. Alternatively, imaging data can be acquired as projections along selected magnetic field gradient directions. During imaging data acquisition, the magnetic resonance imaging controller 40 operates a radio frequency receiver 46 coupled to the coils array 34, as shown, or coupled to the whole body coil 32, to acquire magnetic resonance samples that are stored in a magnetic resonance data memory 50.

The imaging data are reconstructed by a reconstruction processor 52 into an image representation. In the case of k-space sampling data, a Fourier transform-based reconstruction algorithm can be employed. Other reconstruction algorithms, such as a filtered backprojection-based reconstruction, can also be used depending upon the format of the acquired magnetic resonance imaging data. For SENSE imaging data, the reconstruction processor 52 reconstructs folded images from the imaging data acquired by each coil, and then combines the folded images along with coil sensitivity parameters to produce an unfolded reconstructed image.

The reconstructed image generated by the reconstruction processor 52 is stored in an image memory 54, and can be displayed on a user interface 56, stored in non-volatile memory, transmitted over a local intranet or the Internet, viewed, stored, manipulated, or so forth. The user interface 56 can also enable a radiologist, technician, or other operator of the magnetic resonance imaging scanner 10 to communicate with the magnetic resonance imaging controller 40 to select, modify, and execute magnetic resonance imaging sequences.

Optionally, the main Bₒ magnetic field is actively shimmed during the course of an imaging session by a shimming processor 60. In one embodiment, the shimming processor 60 computes one or more shim currents based on magnetic field data acquired by the whole body coil 32 or by the coils of the coils array 34 during a pre-scan dedicated shimming magnetic resonance pulse sequence. The shim current or currents computed by the shimming processor 60 are applied to shim coils 61 of the main magnetic field coils 20 by a main Bₒ magnetic field shims controller 62.

In another embodiment, the shimming processor 60 computes shimming current or currents based on measurements of the main Bₒ magnetic field acquired by an array of magnetic field sensors 64, 66, 68, 70 disposed at selected locations in the bore 14 or inside the housing 12 within the main Bₒ magnetic field. In addition to the four sensors 64, 66, 68, 70 shown in FIG. 1, other magnetic field sensors may be disposed on the portion of the scanner 10 that is cut away in the view of FIG. 1. More generally, two or more magnetic field sensors are disposed at different positions within the bore 14 or inside of the housing 12 to provide spatial information about the main Bₒ magnetic field. The sensors 64, 66, 68, 70 can be Hall effect magnetic field sensors, magnetic resonance-based sensors such as frequency lock coils, independent resonance-based sensors that include their own dedicated resonance material and radio frequency excitation systems, or so forth.

The magnetic field sensors 64, 66, 68, 70 are monitored by a magnetic field sensors readout 72 that acquires the readings, optionally formats or otherwise processes the readings, and communicates the magnetic field measurements to the shimming processor 60. In one embodiment, the magnetic field sensors 64, 66, 68, 70 and the magnetic field sensors readout 72 collectively define a magnetic field camera that outputs magnetic field non-uniformity measurements in the form of spherical harmonics components. The non-uniformity measurements are used in one embodiment to adjust current to the shim coils 61 and in another embodiment to adjust the reconstruction processor 52 to account for the non-uniformity.

With reference to FIG. 2, in one embodiment that employs the sensors 64, 66, 68, 70, each sensor is a magnetic resonance-based sensor that is independent of the magnetic resonance imaging. For example, FIG. 2 diagrammatically shows a suitable magnetic resonance-based sensor 80 that includes a radio frequency generator 82 and a transmit coil or antenna 84. The transmitted radio frequency energy excites magnetic resonance in a sample 86 disposed near the coil or antenna 84. A receive coil or antenna 88 also disposed near the sample 86 picks up the magnetic resonance of the sample 86, and the signal is measured by a radio frequency receiver or sensor 90. Rather than having separate transmit and receive antennas 84, 88, a common transmit/receive antenna with suitable send/receive switching can be employed. The sample 86 is disposed in the main magnetic field, for example at the position of one of the sensors 64, 66, 68, 70 shown in FIG. 1. The antennae 84, 88 are typically disposed near the sample 86 to promote radio frequency coupling. However, the radio frequency generator 82 and the radio frequency receiver or sensor 90 can be disposed inside of or outside of the main Bₒ magnetic field.

In another embodiment, the shimming processor 60 computes shimming current or currents based on measurements of the main Bₒ magnetic field acquired by considering the individual elements of a phased array of receivers 34 for the magnetic resonance imaging experiment to provide substantially the same information as a set of receivers 64, 66, 68, 70 shown in FIG. 1. More generally a phased array coil with two or more elements dispersed at different positions within the bore may be used to provide spatial information about the main Bₒ magnetic field. This may be achieved by measuring signal being generated for the magnetic resonance imaging experiment, or by introducing additional measurements into the magnetic resonance imaging experiment for the purpose of determining the spatial distribution of the main Bₒ magnetic field.

In one embodiment, the sample 86 is a fluorine, deuterium, or other sample having a resonance frequency substantially different from that of the ¹H resonance typically imaged in magnetic resonance imaging. In this embodiment, the radio frequency sensor 80 is substantially insensitive to radio frequency excitations produced by the magnetic resonance imaging scanner 10. In another embodiment, the radio frequency generator 82 and transmit coil or antenna 84 are omitted, and the sample 86 is excited by the radio frequency transmitter 44 and the coil 32 or coils array 34 of the scanner 10 at the imaging ¹H magnetic resonance frequency. Such a passive magnetic field sensor arrangement is used, for example, as a frequency lock coil in some scanners. In this embodiment, a plurality of such passive magnetic field sensors or frequency lock coils corresponding to the sensors 64, 66, 68, 70 provides information on spatial non-uniformities of the main Bₒ magnetic field.

In yet another embodiment, the sensors 64, 66, 68, 70 are Hall effect sensors. For example, in FIG. 3, a Hall sensor 100 includes at least one semiconductor film 102 of indium arsenide, gallium arsenide, indium antimonide, or another semiconductor material exhibiting high Hall voltages, formed on a suitable substantially electrically insulating substrate 104. The semiconductor film or stack of films 102 is arranged generally transverse to the main Bₒ magnetic field of the scanner 10. An electric current (I) passing through the semiconductor film 102 generates a Hall voltage (V_{H}) transverse to the direction of electric current flow and transverse to the main Bₒ magnetic field. The polarity and magnitude of the Hall voltage corresponds to the polarity and magnitude, respectively, of the main Bₒ magnetic field. The Hall effect sensor 100 is substantially insensitive to magnetic resonance excitations produced by the magnetic resonance imaging scanner 10.

With reference to FIG. 4, the main Bₒ magnetic field can also be measured by the scanner 10 itself by using an appropriate pulse sequence. In an illustrated example pulse sequence 120, a small-angle radio frequency pulse 122 is applied to produce magnetic resonance. The small-angle radio frequency pulse 122 preferably has a flip angle of less than about 5°, and more preferably has a flip angle of between 1° and 5°. In some embodiments the flip angle of the small-angle radio frequency pulse 122 is less than 1°. The small-angle radio frequency pulse 122 is applied without an accompanying magnetic field gradient pulse to excite the imaging volume. A multi-echo gradient readout is performed along the slice-select direction using a multi-lobed magnetic field gradient 126. In one embodiment, the multi-lobed magnetic field gradient 126 includes five lobes: L1, L2, L3, L4, L5, having a relative lobe area ratio of −a:+b:−b:+b:−a where a and b represent gradient lobe areas and the positive and negative signs represent gradient lobe polarities or directions. In the embodiment illustrated in FIG. 4, the ratio a:b is 1:2. The gradient reversals produce signal refocusing, and gradient echoes are collected during sampling intervals 130, 132 corresponding to lobes L2 and L4. The gradient echoes are reconstructed into projections along the slice-select direction by applying a Fourier transform reconstruction. A complex phase difference of the projections corresponds to the main Bₒ field nonuniformity distribution along the slice-select direction. For a uniform main Bₒ magnetic field along the slice-select direction, the phase difference is zero.

Multi-echo gradient readouts can be repeated along selected directions to provide three-dimensional data for mapping the main Bₒ magnetic field. For example, FIG. 4 shows a second multi-lobed magnetic field gradient 136 along a selected direction transverse to the slice-select direction and at an angle between the phase-encode (y) and readout (x) directions. The multi-lobed magnetic field gradient 136 is produced by a combination of multi-lobed magnetic field gradient components 140, 142 produced by the phase-encode (y) and readout (x) magnetic field gradient coils, respectively. Gradient echoes are read during intervals 144, 146, and are processed by Fourier transforming and complex phase difference computation. Additional multi-echo gradient readouts can be performed along other directions until the magnetic resonance excited by the small-angle radio frequency pulse 122 decays back to equilibrium. Optionally, additional small-angle radio frequency pulses are applied between successive multi-echo gradient readouts to maintain the magnetic resonance.

In yet another approach for measuring spatial data corresponding to the main Bₒ magnetic field, the coils of the coils array 34 are used to provide spatially distributed information about the main Bₒ magnetic field. The coils of the coils array 34 are spatially distributed, and thus can provide spatially distributed information about the main Bₒ magnetic field in a manner similar to that provided by the dedicated magnetic field sensors 64, 66, 68, 70.

When the magnetic field sensor or sensors are substantially insensitive to ¹H magnetic resonances generated by the magnetic resonance imaging scanner 10, such as is the case for the magnetic field sensors 80, 100 of FIGS. 2 and 3, the main Bₒ magnetic field can be monitored substantially any time that the magnetic field gradient coils 30 are inoperative. Thus, data on main Bₒ magnetic field uniformity can be acquired during portions of the imaging pulse sequences in which no magnetic field gradients are imposed by the gradient coils 30. The use of the self-energized resonance-based magnetic field sensor 80 operating at a resonance frequency substantially different from the ¹H resonance processed by the scanner 10 does not perturb the imaged ¹H resonances. Similarly, operation of the Hall effect sensor 100 generally does not perturb the imaged ¹H resonances.

In contrast, when one or more of the coils 32, 34 of the scanner 10 are used for monitoring the main Bₒ magnetic field, or when a resonance-based sensor operating at the imaged ¹H resonance frequency is used, overlap between the imaging and the main Bₒ magnetic field monitoring should be avoided. In such cases, concurrent magnetic resonance imaging and main Bₒ magnetic field measuring is accomplished by temporally interleaving pulse sequences used for magnetic field measurement with imaging pulse sequences.

With reference to FIG. 5, one suitable approach for performing concurrent imaging and main Bₒ magnetic field measurements is described. In one common magnetic resonance imaging methodology, the imaging proceeds by acquiring successive repetitions, frames or dynamics 140, 142, 144 of imaging data. Each repetition, frame or dynamic 140, 142, 144 images a volume of interest. For example, each frame or dynamic 140, 142, 144 may include acquisition of a plurality of imaging slices 156 spanning the volume of interest. Each frame or dynamic 140, 142, 144 typically spans about around 2-3 seconds, although longer or shorter times are possible. Frames or dynamics 140, 142, 144 are generally separated by dead time intervals of a few tens or hundreds of milliseconds.

During each dead time interval, a main Bₒ magnetic field measurement 150, 152, 154 is undertaken. For example, each main Bₒ magnetic field measurement 150, 152, 154 can include the pulse sequence 120 shown in FIG. 4. The main Bₒ magnetic field measurements 150, 152, 154 are each short and can be performed within a dead time interval of a few tens or hundreds of milliseconds. The pulse sequence 120 shown in FIG. 4 can be performed in such a short time interval. In contrast, other typical Bₒ field mapping sequences, such as FASTERMAP, take longer to perform. A pre-scan FASTERMAP sequence typically takes a timeframe 158 of about five seconds, and thus is unsuitable for measuring the main Bₒ magnetic field concurrently with magnetic resonance imaging.

Considering for example the main Bₒ magnetic field measurement 150, the acquired spatial data pertaining to the main Bₒ magnetic field is processed by the shimming processor 60 during a calculation time interval 160, which optionally overlaps the succeeding frame or dynamic 142. The shimming processor 60 computes one or more shimming currents suitable for compensating for main Bₒ magnetic field nonuniformities determined from the data measured during the main Bₒ magnetic field measurement 150. The computed shim current or shim currents are applied by the main Bₒ magnetic field shim controller 62 to correct the main Bₒ magnetic field during a subsequent frame or dynamic, such during the frame or dynamic 144. If the combined the main Bₒ magnetic field measurement 150 and calculation time interval 160 are short enough, then the shimming current or currents may be applied during the next frame or dynamic 142.

With reference to FIG. 6, a diagrammatic representation of the shimming processor 60 is described. A spherical harmonics calculator 170 receives suitable measured main Bₒ magnetic field data and computes spherical harmonic components 172 of the main Bₒ magnetic field. The spherical harmonics 172 are input to a shim current(s) calculator 176 that computes one or more shim currents 178 for applying to the active shims 61 to compensate for the main Bₒ magnetic field nonuniformities. In one embodiment, the shim coils 61 are each designed to produce one or a few spherical harmonic shimming components, so that suitable corrective shim currents 178 are readily computed from the spherical harmonics 172 of the main Bₒ magnetic field.

The magnetic field data received by the spherical harmonics calculator 170 depend upon how the main Bₒ magnetic field is measured. If dedicated magnetic field sensors such as the sensors 64, 66, 68, 70 are employed, then the magnetic field sensors readout 72 preferably automatically converts the readings into spherical harmonics components. That is, the combination of the magnetic field sensors 64, 66, 68, 70 and the readout 72 preferably act as a magnetic field camera. In this case, the spherical harmonics calculator 170 is suitably omitted. Alternatively, the magnetic field measurements are input to the spherical harmonics calculator 170 in a native format, such as in Cartesian (x,y,z) coordinates or cylindrical (ρ,θ,z) coordinates, and the spherical harmonics calculator 170 performs a coordinates transformation to convert the measured sensors data into spherical harmonic components.

If a magnetic resonance sequence such as the sequence 120 shown in FIG. 4 is used to measure the main Bₒ magnetic field data, then the Fourier-transformed gradient readouts γ(L2) and γ(L4) acquired during the gradient lobes L2, L4 respectively, are processed by a phase difference processor 182 to produce the complex phase difference projection Δγ(d) where d represents the projection direction. The spherical harmonics calculator 170 computes spherical harmonics by phase-unwrapping the complex phase difference projection Δγ(d) and fitting the unwrapped complex phase difference projection Δγ(d) to a Legendre polynomial corresponding to a spherical harmonic component.

If data on the spatial distribution of the main Bₒ magnetic field is acquired using a plurality of coils, such as by using the coils array 34, then data 184 for each coil including a resonance frequency (co) and a resonance signal intensity (S) are acquired. A frequency shift calculator 186 computes the frequency distribution by fitting the (S, ω) measurements, corrected for coil sensitivity factors 188, to a suitable magnetic field model, such as a first-order spatial magnetic field distribution model, or by otherwise analyzing the coils data 184 to obtain the magnetic resonance frequency nonuniformity Δω(r) as a function of position r where r is in Cartesian (x,y,z) coordinates, cylindrical (ρ,θ,z) coordinates, or in another suitable coordinates system. The spherical harmonics calculator 170 converts the magnetic resonance frequency nonuniformity Δω(r) to a magnetic field nonuniformity ΔBₒ(r) according to ω=gB, where g is the gyrometric ratio and g≅42.58 MHz/T for ¹H resonance. The spherical harmonics calculator 170 transforms the magnetic field nonuniformity ΔBₒ(r) into spherical harmonics coordinates. Alternatively, the fitting of the (S, ω measurements to obtain the magnetic resonance frequency nonuniformity Δω(r) can be directly performed in spherical harmonics coordinates.

In the illustrated embodiments, the main Bₒ magnetic field measurements are used to compute corrective shim currents for shimming the main Bₒ magnetic field during the course of a magnetic resonance imaging session. In another contemplated embodiment, the main Bₒ magnetic field nonuniformity measurements are used to perform a post-data acquisition correction of the acquired magnetic resonance imaging data that corrects for artifacts in the reconstructed images caused by main Bₒ magnetic field nonuniformity.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A magnetic resonance method comprising:
performing magnetic resonance imaging in a main magnetic field;
measuring spatial data corresponding to the main magnetic field; and
determining at least one main magnetic field nonuniformity parameter from the spatial data corresponding to the main magnetic field; wherein:
the measuring and determining are performed concurrently with the performing of magnetic resonance imaging.

2. The magnetic resonance method as set forth in claim 1, wherein the performing of magnetic resonance imaging comprises:
acquiring a magnetic resonance imaging repetition, frame or dynamic, the acquiring including acquiring volumetric magnetic resonance imaging data;
repeating the acquiring; and
interspersing the measuring between or concurrently with repetitions of the acquiring.

3. The magnetic resonance method as set forth in claim 1, further comprising:
acquiring a magnetic resonance imaging repetition, frame or dynamic, the acquiring including acquiring volumetric magnetic resonance imaging data;
repeating the acquiring;
computing a main magnetic field shim current based on the determined at least one main magnetic field nonuniformity parameter; and
applying the computed main magnetic field shim current during the acquiring of a subsequent magnetic resonance imaging repetition, frame or dynamic.

4. The magnetic resonance method as set forth in claim 1, further comprising:
compensating for a change in the main magnetic field by adjusting the main magnetic field based on the at least one main magnetic field nonuniformity parameter.

5. The magnetic resonance method as set forth in claim 1, further comprising:
compensating for a change in the main magnetic field by adjusting an image reconstruction of imaging data collected by the performing of magnetic resonance imaging based on the at least one main magnetic field nonuniformity parameter.

6. The magnetic resonance method as set forth in claim 1, wherein the measuring and determining comprise:
reading at least two gradient echoes using magnetic field gradients imposed along a selected direction; and
computing a nonuniformity of the main magnetic field along the selected direction from the at least two gradient echoes.

7. The magnetic resonance method as set forth in claim 6, further comprising:
repeating the reading and computing for a plurality of selected directions; and
mapping the main magnetic field based on the computed nonuniformities along the selected directions.

8. The magnetic resonance method as set forth in claim 6, wherein the reading of at least two gradient echoes comprises:
applying a balanced magnetic field gradient along the selected direction, the balanced magnetic field gradient having at least two lobes of same polarity separated by a lobe of opposite polarity; and
reading the at least two gradient echoes during the two lobes of same polarity.

9. The magnetic resonance method as set forth in claim 6, wherein the reading of at least two gradient echoes comprises:
prior to the reading of the at least two gradient echoes, applying a radio frequency excitation.

10. The magnetic resonance method as set forth in claim 9, wherein the applying of a radio frequency excitation comprises:
applying a radio frequency excitation having a low flip angle.

11. The magnetic resonance method as set forth in claim 9, further including:
reading at least two other gradient echoes using magnetic field gradients imposed along a different direction; and
wherein the readings along the selected direction and along the different direction detect magnetic resonance excited by the same said applied radio frequency excitation.

12. The magnetic resonance method as set forth in claim 6, wherein the computing comprises:
Fourier transforming each gradient echo to reconstruct a projection along the selected direction; and
computing a complex phase difference between the projections reconstructed from the at least two gradient echoes, the nonuniformity of the main magnetic field along the selected direction corresponding to the complex phase difference.

13. The magnetic resonance method as set forth in claim 12, wherein the reading of at least two gradient echoes using magnetic field gradients imposed along a selected direction comprises:
imposing the multi-lobe magnetic field gradient includes at least five lobes along the selected direction, the multi-lobe magnetic field gradient including a −a:+b:−b:+b:−a lobe area ratio where a and b represent gradient lobe areas and the positive and negative signs represent gradient lobe polarities; and
reading the at least two gradient echoes during the two +b lobes.

14. The magnetic resonance method as set forth in claim 1, wherein:
the measuring of spatial data corresponding to the main magnetic field includes reading coils of an array of spatially separated coils.

15. The magnetic resonance method as set forth in claim 14, wherein:
the performing of magnetic resonance imaging includes imaging using the array of spatially separated coils, the spatial data corresponding to the main magnetic field being extracted from the magnetic resonance imaging data.

16. The magnetic resonance method as set forth in claim 1, wherein the measuring of spatial data corresponding to a main magnetic field comprises:
exciting and sampling magnetic resonance at a resonance frequency different from the resonance frequency used in performing the magnetic resonance imaging; and
deriving spatial data corresponding to the main magnetic field from the sampled magnetic resonance.

17. The magnetic resonance method as set forth in claim 16, wherein the exciting and sampling of magnetic resonance at a resonance frequency different from the resonance frequency used in performing the magnetic resonance imaging is performed during the magnetic resonance imaging and further comprises:
sampling magnetic resonance at the resonance frequency different from the resonance frequency used in performing the magnetic resonance imaging at a plurality of spatial locations.

18. The magnetic resonance method as set forth in claim 1, wherein the measuring of spatial data corresponding to a main magnetic field comprises:
exciting and sampling magnetic resonance in an imaging subject of the magnetic resonance imaging; and
deriving spatial data corresponding to the main magnetic field from the sampled magnetic resonance.

19. A magnetic resonance imaging apparatus comprising:
a means for performing magnetic resonance imaging in a main magnetic field;
a means for measuring spatial data corresponding to the main magnetic field; and
a means for determining at least one main magnetic field nonuniformity parameter from the spatial data corresponding to the main magnetic field.

20. The magnetic resonance imaging apparatus as set forth in claim 19, wherein the measuring means comprises:
a plurality of magnetic field sensors disposed in the main magnetic field, the plurality of magnetic field sensors operating independently from the imaging means.

21. The magnetic resonance imaging apparatus as set forth in claim 20, wherein the magnetic field sensors are selected from a group consisting of:
Hall effect magnetic field sensors,
resonance-based active magnetic field sensors operating at a resonance frequency different from a magnetic resonance frequency of the acquiring means, and
a plurality of field-lock coils tuned to a magnetic resonance frequency of the acquiring means.

22. The magnetic resonance imaging apparatus as set forth in claim 19, wherein the measuring means comprises:
one or more radio frequency receive coils of the imaging means.

23. The magnetic resonance imaging apparatus as set forth in claim 19, further comprising:
a ferromagnetic structure disposed in the main magnetic field, the ferromagnetic structure inducing changes in the main magnetic field over time responsive to the magnetic resonance imaging.

24. The magnetic resonance imaging apparatus as set forth in claim 19, further comprising:
a means for adjusting the main magnetic field during the magnetic resonance imaging based on the at least one main magnetic field nonuniformity parameter.

25. The magnetic resonance imaging apparatus as set forth in claim 19, further comprising:
a means for reconstructing imaging data acquired by the means for performing magnetic resonance imaging, the reconstructing means adjusting the reconstructing based on the at least one main magnetic field nonuniformity parameter.

26. A magnetic resonance imaging apparatus comprising:
a magnetic resonance imaging scanner performing magnetic resonance imaging, the scanner including:
a main magnet generating a main magnetic field,
magnetic field gradient coils, and
at least one radio frequency antenna;
at least one magnetic field sensor measuring spatial data corresponding to the main magnetic field; and
a processor programmed to perform the method of claim 1 to determine the nonuniformity parameter.

27. The magnetic resonance imaging apparatus as set forth in claim 26, further comprising:
shim coils for shimming the main magnetic field; and
a reconstruction processors;
the processor being operatively connected with at least one of the shim coils and the reconstruction processor to adjust at least one of shim coil currents and resonance data reconstruction in accordance with the nonuniformity parameter.
